(19) United States
(12) Patent Application Publication
(10) Pub. No.: US 2003/0002128 A1
(43) Pub. Date: Jan. 2, 2003

(54) Optical isolator

(75) Inventor: Toshiaki Watanabe, Gunma (JP)

Correspondence Address: HOGAN & HARTSON L.L.P., 500 S. GRAND AVENUE, SUITE 1900, LOS ANGELES, CA, 90071-2611, US

(73) Assignee: SHIN-ETSU CHEMICAL CO., LTD

(21) Appl. No.: 10/172,680

(22) Filed: Jun. 14, 2002

(30) Foreign Application Priority Data
Jun. 14, 2001 (JP) 2001-180556

(51) Int. Cl. G02F 1/09

(52) U.S. Cl. 359/280

(57) ABSTRACT

An optical isolator constituted by disposing optical elements comprising at least three polarizers and two faraday rotators with respect to a forward direction of light, wherein magnets, which are magnetized so that these magnetic poles are different from each other, are oppositely disposed by inserting the optical elements therebetween, the optical elements are constituted by disposing a first polarizer, a first faraday rotator, a second polarizer, a second faraday rotator and a third polarizer in order, the first and the third polarizers have the same transmission polarizing direction, and a faraday rotation direction of the first faraday rotator is different from that of the second faraday rotator toward a forward direction of light, and there is provided a reliable, productive and low cost multistage optical isolator having high backward loss and that both an incident and exit transmission polarizing directions are identical with each other.

### BACKGROUND OF THE INVENTION

1. Field of the Invention

The present invention relates to an optical isolator used for optical communication or optical measurement, particularly relates to an optical isolator comprising faraday rotators in multistage and having high isolation (backward loss).

2. Related Art

High performance semiconductor laser has been used as light source for optical fiber communication of recent years to transmit high capacity at a high speed. Oscillation characteristic of this laser is influenced sensitively by reflected light from a fiber or the like, so that an optical isolator having high backward loss has been essentially required.

Further, accompanied by high performance of laser or high integration level of optical elements, it has been required that both incident and exit polarizing directions are identical with each other.

A conventional multistage optical isolator is constituted toward a forward direction of light as follows.

\mathring{1} Two isolators of which magnetic poles are opposite to each other are connected.

\mathring{2} A radial orientation magnet is used so that reverse direction magnetic field is impressed to two faraday rotators respectively by one magnet (see Japanese Patent Laid-open Publication No. 1-142525).

\mathring{3} Disposition of magnetic pole in one magnet is contrived (see Japanese Patent Laid-open Publication No. 2-108017).

However, the above techniques suffer from problems as follows. In \mathring{1}, an assembly such that magnets having opposite magnetic poles to each other are closely disposed is complicated. In \mathring{2}, this structure is not adequate for a structure using a small size magnet. In \mathring{3}, magnetic pole structure of magnets is complicated, and it is difficult to magnetize the magnets at once after assembling them. Namely, those methods are not suited for mass production and if those methods are used, its cost will increase.

Additionally, as a method to set an incident transmission polarizing direction and an exit transmission polarizing direction uniformly, in addition to the above methods, it is also conceivable that rotator or faraday rotator is disposed on an incident side or exit side of an isolator. However, it suffers from problems of increase of parts, decrease of optical transmittance, increase in size due to increase of optical path, and the like, so that this method does not become an effective means to solve the problems.

### SUMMARY OF THE INVENTION

Therefore, the present invention was accomplished in view of the aforementioned problems, and its main object is to provide a reliable, productive and low cost multistage optical isolator having high backward loss and that both an incident and exit transmission polarizing directions are identical with each other.

In order to solve the above-mentioned problems, the present invention provides an optical isolator constituted by disposing optical elements comprising at least three polarizers and two faraday rotators with respect to a forward direction of light, wherein magnets, which are magnetized so that these magnetic poles are different from each other, are oppositely disposed by inserting the optical elements therebetween, the optical elements are constituted by disposing a first polarizer, a first faraday rotator, a second polarizer, a second faraday rotator and a third polarizer in order, and the first and the third polarizers have the same transmission polarizing direction and a faraday rotation direction of the first faraday rotator is different from that of the second faraday rotator toward a forward direction of light.

As described above, the optical isolator is constituted in multistage, so that the reliable, productive and low cost optical isolator having high backward loss and that both an incident and exit transmission polarizing directions are identical with each other can be provided.

In this case, the optical elements are constituted by further disposing a fourth polarizer between the first faraday rotator and the second faraday rotator.

As described above, the optical elements, which are constituted by further disposing a fourth polarizer in the aforementioned optical elements of the multistage optical isolator, also have higher backward loss and that both an incident and exit transmission polarizing directions are identical with each other, so that the reliable, productive and low cost multistage optical isolator can be provided.

Further, in this case, the first and the second faraday rotators are both latching type faraday rotators, and the magnets are omitted from the optical isolator.

As described above, in the case that the latching type (self saturation type) faraday rotator without the need for a magnet is used for the optical element, if the faraday rotators are assembled after they are previously magnetized so that each faraday rotator has different faraday rotation directions, magnets can be omitted therefrom, and a reliable isolator having high backward loss and that both an incident and exit transmission polarizing directions are identical with each other can be downsized.

And, according to the above-described optical isolator, the optical elements (polarizers and faraday rotators) and/or magnets are fixed on a flat plate type substrate, and when mounting them, a transmission polarizing direction of polarizers disposed on both ends of a forward direction of light is in parallel with a disposition plane of the substrate.

As described above, since the optical elements are assembled by disposing them on the flat plate type substrate, the optical elements can be located easily and precisely, so that a high-precision and reliable optical isolator can be obtained.

Further, an undersurface of the substrate is mounted on an LD (Laser Diode) module, so that the optical elements can be precisely identical with an incident polarizing direction of an LD tip. Furthermore, since an exit polarizing direction is identical with an incident polarizing direction, even if components such as a waveguide having polarization dependence are disposed on the substrate after light exits, optical coupling efficiency is not degraded.

Additionally, as for the above optical isolator, it is preferable that at least a polarizer in an incident side is obliquely disposed, the optical element is obliquely disposed by oblique-processing a cut surface of the optical element, and the optical element is inclined from a direction perpendicular to a mating surface of the optical element and the substrate along a forward direction of light.

As described above, in order to prevent optical reflection of an incident surface, optical elements can be obliquely disposed with respect to the incident direction. And in this case, if optical isolators, which are obliquely processed on its cut surface, are used, it is not necessary to an oblique-processing for the substrate, which is high cost and difficult to maintain its precision. Further, if the optical elements are inclined from a direction perpendicular to a mating surface of the optical element and a substrate along a forward direction of light, a certain optical transmittance can be maintained without decrease of an effective area of the optical elements, so that a reliable optical isolator having high backward loss and that both an incident and exit transmission polarizing directions are identical with each other can be obtained.

As described above in detail, the optical isolator of the present invention is reliable and has high backward loss and that both an incident and exit transmission polarizing directions are identical with each other, and it can be easily mass-produced and provided at a lower cost.

### BRIEF EXPLANATION OF THE DRAWINGS

FIG. 1 includes explanatory views showing a first aspect of an optical isolator of the present invention, (a) is a plain view and (b) is an A-A line cross sectional view.

FIG. 2 is a cross sectional view showing a second aspect of an optical isolator of the present invention.

FIG. 3 shows light transmission polarizing directions in each optical element surface in FIG. 1 and FIG. 2.

FIG. 4 includes explanatory views showing a third aspect of an optical isolator of the present invention, (a) is a plain view, (b) is a B-B line cross sectional view and (c) is a front view.

FIG. 5 includes explanatory views showing an example of a conventional optical isolator as a prior art, (a) is a plain view, (b) is a side view and (c) is a front view.

### PREFERRED EMBODIMENTS OF THE INVENTION

Hereinafter, embodiments of the present invention will be explained with reference to the appended drawings. However, the present invention is not limited thereto.

According to the present invention, materials having chemical compositions such that each faraday rotation direction is different from each other in the same magnetic field direction are used for faraday rotators, which constitutes optical elements of the multistage optical isolator. As the result:

\mathring{1} its magnet composition can be simplified;

\mathring{2} after assembled and adjusted, magnets can be magnetized at once;

\mathring{3} it is possible that both an incident and exit transmission polarizing directions are identical with each other; and

\mathring{4} since faraday rotators of which compositions are different from each other are used, a multistage optical isolator has high backward loss and that temperature dependence and wave length dependence of its optical characteristics can be mitigated.

Namely, the first aspect of the present invention is that an optical isolator constituted by disposing optical elements comprising at least three polarizers and two faraday rotators with respect to a forward direction of light, wherein magnets, which are magnetized so that these magnetic poles are different from each other, are oppositely disposed by inserting the optical elements therebetween, the optical elements are constituted by disposing a first polarizer, a first faraday rotator, a second polarizer, a second faraday rotator and a third polarizer in order, the first and the third polarizers have the same transmission polarizing direction, and a faraday rotation direction of the first faraday rotator is different from that of the second faraday rotator toward a forward direction of light.

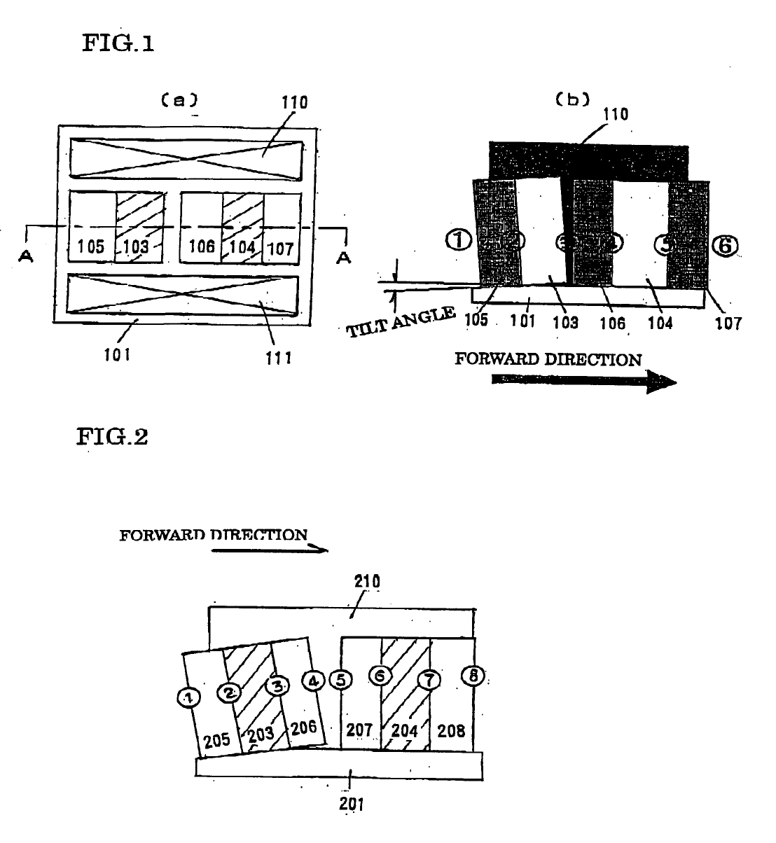

FIG. 1 shows the first aspect of the present invention.

FIG. 1(a) is a plain view, and FIG. 1(b) is an A-A line cross sectional view along a transmission direction of light. This optical isolator is constituted by disposing optical elements of three polarizers 105, 106 and 107, and two faraday rotators 103 and 104 with respect to a forward direction of light, and rectangular parallelepiped magnets 110 and 111, which are magnetized so that these magnetic poles are different from each other, are oppositely disposed by inserting the optical elements therebetween. These optical elements are constituted by disposing the first polarizer 105, the first faraday rotator 103, the second polarizer 106, the second faraday rotator 104 and the third polarizer 107 in order, and that the first and third polarizers have the same transmission polarizing direction, and a faraday rotation direction of the first faraday rotator is different from that of the second faraday rotator toward a forward direction of light.

And, in order to obliquely dispose the first polarizer 105 and first faraday rotator 103 as an optical element in an incident side, an incident side surface of a substrate 101 is obliquely processed. The first polarizer 105 and the third polarizer 107 have the transmission polarizing directions on a level with the substrate. The magnets 110 and 111 are magnetized (magnetized after the isolator is assembled) to the forward direction of light (or backward direction of light), and in the same magnetic field direction, the first faraday rotator 103 and the second faraday rotator 104 of which chemical compositions are different from each other so that these faraday rotation directions are different from each other are disposed.

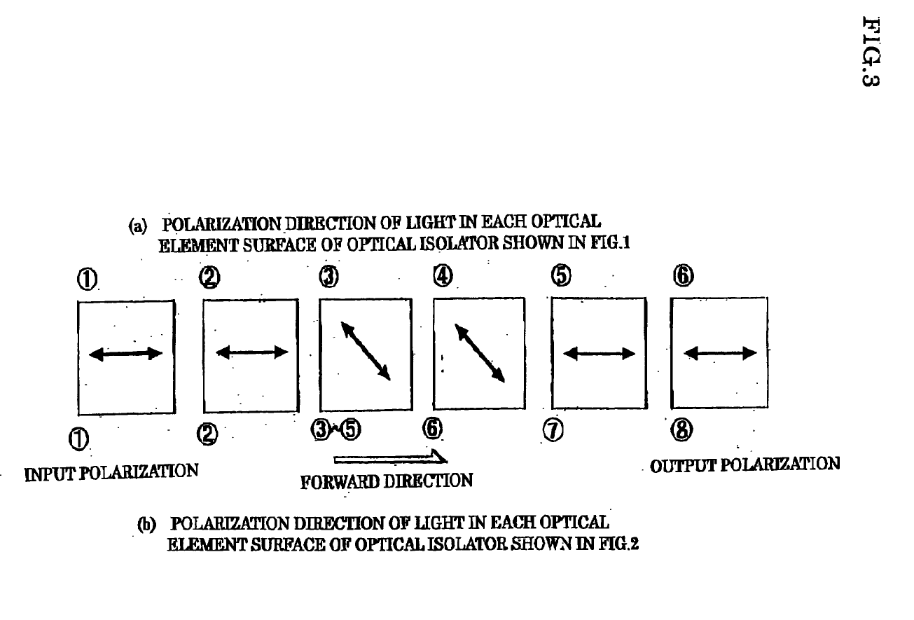

FIG. 3(a) shows a transmission polarizing direction of light on each surface of optical elements (in the condition that light, which comes in a surface \mathring{1}, transmits to a surface \mathring{6}) , and the transmission polarizing directions of the surface \mathring{1} and \mathring{6} are identical with each other.

By using thus-composed optical isolator, both the incident and exit transmission polarizing directions can be easily identical with each other, and an undersurface of the substrate is mounted on an LD (Laser Diode) module, so that the optical elements can be precisely identical with the incident polarizing direction of an LD tip. Further, since the exit polarizing direction is identical with the incident polarizing direction, even if components such as a waveguide having polarization dependence are disposed on the substrate after light exits, optical coupling efficiency is not degraded.

Next, FIG. 2 shows the second aspect of the present invention.

This optical isolator is constituted by disposing optical elements of four polarizers 205, 206, 207 and 208, and two faraday rotators 203 and 204 on a substrate 201 with respect to a forward direction of light, and rectangular parallelepiped magnets 210 and 211 (not shown), which are magnetized so that these magnetic poles are different from each other, are oppositely disposed by inserting the optical elements therebetween. These optical elements are constituted by disposing the first polarizer 205, the first faraday rotator 203, the second polarizer 206, the fourth polarizer 207, the second faraday rotator 204 and the third polarizer 208 in order, and that the first and third polarizers have the same transmission polarizing direction, and faraday rotation directions of the first and the second faraday rotators are different from each other toward a forward direction of light.

In FIG. 2, two polarizers of the second polarizer 206 and the fourth polarizer 207 are disposed between the first and the second faraday rotator, but in this case, as shown in FIG. 3(b), the transmission polarizing directions of the surfaces \mathring{1} and \mathring{8} are also identical with each other. Further, in order to obliquely dispose the first polarizer 205, the first faraday rotator 203 and the second polarizer 206 as optical elements in an incident side, an incident side surface of the substrate 201 is obliquely processed.

This structure and action effect can be explained as in the first aspect (see FIG. 3(b)).

As described above, the optical isolator such that the fourth polarizer is additionally disposed in the optical element of the multistage optical isolator also have the feature that both the incident and exit transmission polarizing directions are identical with each other, and higher backward loss can be obtained. Accordingly, there can be provided a reliable, productive and low cost multistage optical isolator.

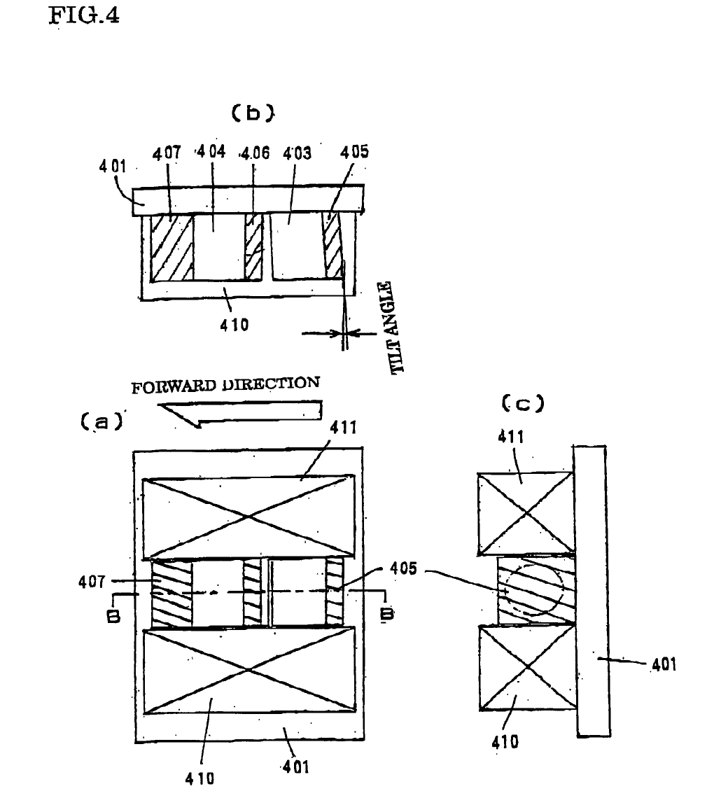

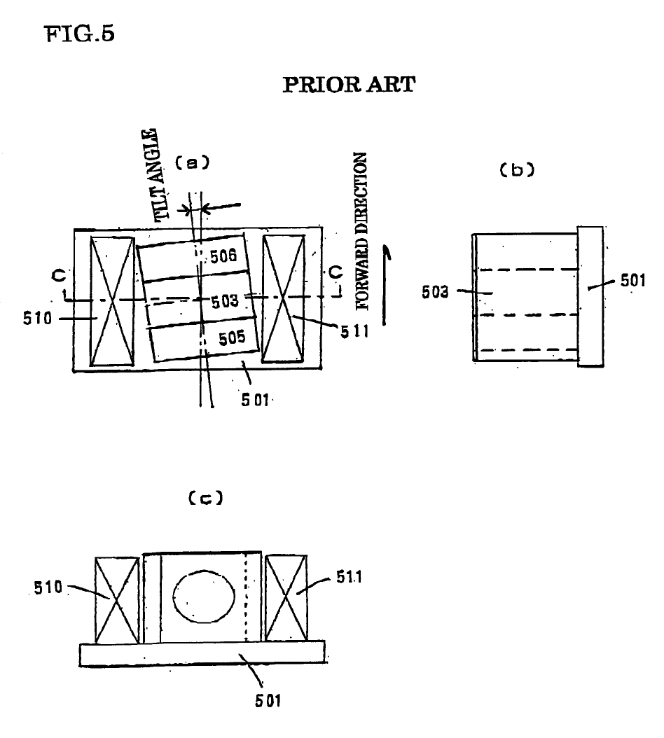

FIG. 4 shows the third aspect of the present invention.

FIG. 4(a) is a plain view and (b) is a B-B line cross sectional view along a transmission direction of light. This optical isolator is constituted by disposing optical elements of three polarizers 405, 406 and 407, and two faraday rotators 403 and 404 on a substrate 401 with respect to a forward direction of light, and rectangular parallelepiped magnets 410 and 411, which are magnetized so that these magnetic poles are different from each other, are oppositely disposed by inserting the optical elements.

And, in order to obliquely dispose the first polarizer 405 and the first faraday rotator 403 as optical elements in an incident side, a mating surface of the optical elements to the substrate are obliquely processed, and the oblique direction is inclined perpendicular to the mating surface of the optical elements and substrate along a forward direction of light.

The transmission polarizing direction in this aspect can be explained as in the first aspect (see FIG. 3(a)).

Recently, such a construction as a flat plate type optical isolator has been used (see Japanese Patent Laid-open Publication No. 10-227996), and the present invention uses a flat plate type substrate, so that optical elements can be located easily and precisely, and thus a high-precision and reliable optical isolator can be obtained.

Further, as for the optical isolator of the present invention, optical elements (polarizers and faraday rotators) and/or magnets are fixed on a flat plate type substrate, and when mounting them, a transmission polarizing direction of polarizers disposed on both ends of a forward direction of light is in parallel with a disposition plane of the substrate.

According to this, an undersurface of the substrate is mounted on an LD (Laser Diode) module, so that the optical elements can be identical with an incident polarizing direction of an LD tip. Further, since an exit polarizing direction is identical with an incident polarizing direction, even if components such as a waveguide having polarization dependence are disposed on the substrate, optical coupling efficiency is not degraded.

Furthermore, in the aspects of the present invention, when optical elements are disposed on a flat plate type substrate, they are obliquely disposed thereon with respect to an incident direction in order to avoid light reflection on an incident surface. In this case, if optical elements, which are merely cut vertically, are obliquely disposed in parallel to a mating surface between the optical elements and the substrate, an effective area of the optical elements will be reduced. Also, if a necessary effective diameter of the optical elements is intended to be secured, a size of the optical isolator in a lateral direction will be increased. Accordingly, as the first and second aspects, it is preferable that the optical elements are obliquely disposed from a direction perpendicular to the mating surface of the optical element and the substrate along a forward direction of light. However, if the substrate itself is intended to be inclined as the first and second aspects of the present invention, it may suffer from problems that processing cost of the substrate is increased and it becomes harder to locate optical elements.

In order to solve the above problems, it is preferable that optical elements are previously processed to have an end face inclined at a certain angle.

Since the optical elements are obliquely processed on its mating surface toward the substrate in order to obliquely dispose the optical elements,

\mathring{1} it is relieved of the difficulty to reserve the precision of a oblique-processing of the substrate;

\mathring{2} a dimension in a horizontal direction of the substrate is reduced so that it is downsized;

\mathring{3} since a distance between magnets can be narrowed, sufficient magnetic field can be supplied to faraday rotators; and

\mathring{4} a surface of the substrate is identical with a inclined surface, so that a precision of an incident angle is improved better than the case that a magnet in a side face direction is used as a reference plane. And as a result, advantageous effects for coupling in mass production such as agreement of optical paths or agreement of optical exit axes can be obtained.

Further, according to the fourth aspect of the present invention (not shown), the first and the second faraday rotators are both latching type faraday rotators, and the magnets are omitted from the optical isolator.

As described above, in the case that a latching type (self saturation type) faraday rotator is used for the optical element, if the faraday rotators are assembled after they are previously magnetized so that each faraday rotator has a different faraday rotation direction, a reliable isolator having high backward loss and that both an incident and exit transmission polarizing directions are identical with each other can be obtained.

In this regard, as a prior art, a polarizer 505, faraday rotator 503 and polarizer 506 are bonded, an optical element, which is processed in a rectangle parallelepiped having a square in an incident and exit end face, are obliquely disposed on a substrate 501 from a transmission axis of light, and bar magnets 510 and 511 are disposed in parallel with a transmission direction of light to constitute an optical isolator.

As clear from the drawing, if optical elements are processed in a rectangular parallelepiped, an effective area for the optical elements with respect to a direct advance light in both an incident end face and exit end face is reduced. Further, in the case that the substrate is processed into a flat plate, the optical elements must be obliquely disposed in parallel with the substrate, so that an external shape of the isolator with respect to a horizontal direction is enlarged. Furthermore, there is a possibility that since a distance between magnets is extended, sufficient magnetic field can not be supplied to the faraday rotator.

### EXAMPLE

Hereinafter the present invention will be explained in reference to examples, but the present invention is not limited thereto.

### Example 1

An optical isolator of the present invention as shown FIG. 1 was manufactured.

In Examples, a polarizing glass, Polarcor, manufactured by Corning incorporated was used as a polarizing material of a polarizer, and (TbEuBi)₃(FeGa)₅O₁₂ or (GaBi)₃(FeGa)₅O₁₂ was used as a material of a faraday rotator.

First, there were prepared a polarizer 105 having a size of 15 mm×15 mm×0.5 mm comprising a polarizing glass of which one side was applied with an AR coating for air and the other side was applied with an AR coating for adhesive, and also prepared a faraday rotator 103 having a size of 15 mm×15 mm×0.6 mm comprising (GaBi)₃(FeGa)₅O₁₂ of which one side was applied with an AR coating for adhesive and the other side was applied with an AR coating for air. The polarizer 105 was bondedly fixed with the faraday rotator 103 through an epoxy adhesive on each AR coating face for adhesive, and then the bonded optical elements were cut into a size of 1.25×1.25 mm.

Next, there were prepared two polarizers 106 and 107 each having a size of 15 mm×15 mm×0.5 mm comprising a polarizing glass of which one side was applied with an AR coating for air and the other side was applied with an AR coating for adhesive. And there was also prepared a faraday rotator 104 having a size of 15 mm×15 mm×0.6 mm comprising (TbEuBi)₃(FeGa)₅O₁₂ of which both sides were applied with an AR coating for adhesive. The polarizers 106 and 107 were bonded to the faraday rotator 104 on each AR coating face for adhesive respectively through an epoxy adhesive. At this time, each polarizing glass bonded at both ends of the faraday rotator 104 respectively were located so that each transmission polarizing direction was relatively at 45°, and after they were jointly fixed, the bonded optical elements were cut into a size of 1.25×1.25 mm.

Sm—Co magnets 110 and 111, and the above optical elements of the polarizer 105—the faraday rotator 103, and the polarizer 106—the faraday rotator 104—the polarizer 107, which were cut into a size of 1.25×1.25 mm, were jointly fixed on a substrate 101, which was obliquely processed at 8° on one side. Then, the magnets were magnetized so as to have the same magnetizing direction as an optical transmission direction shown in FIG. 1(b), and an isolator was assembled. Since the substrate 101 was obliquely processed, a residual reflection in the AR coating face for air of the polarizer 105 with respect to an incident light from a direction of the polarizer 105 can be eliminated to a different direction (angle) from the incident light.

The function of the assembled optical isolator is explained with reference to FIG. 3. A laser enters to a face \mathring{1}, and only the component of a polarized wave in parallel with the substrate 101 transmits through the polarizer 105 and reaches to a face \mathring{2}. At this moment, a polarized light direction is rotated clockwise at 45° in the faraday rotator 103 and the laser reaches the polarizer 106. A transmission polarizing direction of the polarizer 106 is previously brought into line with a polarizing direction in a face \mathring{3} in assembly, the laser can reach the faraday rotator 104. In the faraday rotator 104, the polarizing direction is rotated in the reverse direction (counterclockwise) at 45°, and the laser is transmitted. As described above, the faraday rotator 106 and the faraday rotator 107 are located so that each relative angle is 45°, i.e., a transmission polarizing direction in a face \mathring{5} is identical with a transmission direction of the polarizer 107, and a transmission polarizing direction is in parallel with the substrate 101 like \mathring{6} and identical with the transmission direction \mathring{1} when light enters. Therefore, incident and exit transmission polarizing directions are identical with each other, and its polarized wave direction is maintained.

On the other hand, the light, which enters from a backward direction, is only a component of a transmission polarizing direction in the polarizer 107, of which transmission direction is identical with \mathring{6}, the light is rotated at 45° (rotated counterclockwise at 45° observed from the face \mathring{1} direction) in a faraday rotator 104, and the transmission direction is orthogonal to the transmission polarizing direction of the polarizer 106, so that the light is intercepted. The light escaping from the polarizer 106 is rotated at 45° (rotated clockwise at 45° observed from the face \mathring{1} direction) in the faraday rotator 101, and reaches to the polarizer 105. In this case, the transmission direction is also orthogonal to the transmission polarizing direction of the polarizer 105, so that the light is intercepted.

The characteristics of the specimen of the optical isolator were determined. The characteristics of this optical isolator at 1550 nm were that the forward loss of the incident light, which entered from the direction of the polarizer 105 was 0.30 dB, the transmission polarizing directions of the polarizer 105 and the polarizer 107 were identical with each other, and the backward loss of the incident light, which entered from the direction of the polarizer 107 was 64 dB.

### Example 2

An optical isolator of the present invention as shown FIG. 2 was manufactured. The same materials of the optical elements in Example 1 were used for each optical element.

There were prepared two polarizers 205 and 206 each having a size of 15 mm×15 mm×0.5 mm comprising a polarizing glass of which one side was applied with an AR coating for air and the other side was applied with an AR coating for adhesive. And there was also prepared a faraday rotator 203 having a size of 15 mm×15 mm×0.6 mm comprising (GaBi)₃(FeGa)₅O₁₂ of which both sides were applied with an AR coating for adhesive. The polarizers 205 and 206 were bondedly fixed with the faraday rotator 203 on each AR coating face for adhesive respectively through an epoxy adhesive so that each transmission polarizing direction was relatively at 45° (the transmission polarizing direction of the polarizer 206 was rotated clockwise observed from the polarizer 205), and the bonded elements were cut into a size of 1.25×1.25 mm.

Next, there were prepared two polarizers 207 and 208 each having a size of 15 mm×15 mm×0.5 mm comprising a polarizing glass of which one side was applied with an AR coating for air and the other side was applied with an AR coating for adhesive. And there was also prepared a faraday rotator 204 having a size of 15 mm×15 mm×0.6 mm comprising (TbEuBi)₃(FeGa)₅O₁₂ of which both sides were applied with an AR coating for adhesive. The polarizers 207 and 208 were bonded to the faraday rotator 204 on each AR coating face for adhesive respectively through an epoxy adhesive so that each transmission polarizing direction was relatively at 45° (the transmission polarizing direction of the polarizer 208 was rotated clockwise at 45° observed from the polarizer 207), and after they were bondedly fixed, the bonded elements were cut into 1.25×1.25 mm.

A Sm—Co magnet 210, and the above optical elements of the polarizer 205—the faraday rotator 203—the polarizer 206, and the polarizer 207—the faraday rotator 204—the polarizer 208 bonded in order were bondedly fixed on a substrate 201, which was obliquely processed at 8° on one side. Then, the magnet was magnetized so as to have the same magnetizing direction as an optical transmission direction shown in FIG. 2, and an isolator was assembled.

The characteristics of the specimen of the optical isolator were determined. The characteristics of this optical isolator at 1550 nm were that the forward loss of the incident light, which entered from the direction of the polarizer 205 was 0.34 dB, the transmission polarizing directions of the polarizer 205 and the polarizer 208 were identical with each other, and the backward loss of the incident light, which entered from the direction of the polarizer 208 was 78 dB.

### Example 3

Except that latching type faraday rotators were used as a substitute for the faraday rotators 103 and 104 used in Example 1, after bonding process steps were conducted in the same process as Example 1, a magnetization was conducted so that it brought the faraday rotator 103 into a faraday rotation rotated clockwise at 45° and brought the faraday rotator 104 into a faraday rotation rotated counterclockwise at 45°, and an isolator was assembled.

In the case of using latching type faraday rotators, since there was no necessary to dispose the magnets 110 and 111 as in Example 1, magnets were not disposed on the substrate in Example 3.

The characteristics of the specimen of the optical isolator were determined. The forward loss of this optical isolator was 0.24 dB, the transmission polarizing directions of the polarizers 105 and the polarizer 107 were identical with each other, and its backward loss was 67 dB.

According to the present invention, in the case of the optical isolator used in Example 2, latching type faraday rotators can also be used as a substitute for the faraday rotators 203 and 204, i.e., optical elements can be disposed without magnets to assemble an optical isolator.

### Example 4

An optical isolator of the present invention as shown in FIG. 4 was manufactured. By using the same optical element materials as Example 1, a polarizer 405 and a faraday rotator 403 were bonded to each other, and they are obliquely processed at 8° on a mating face with a substrate 401 and its opposite face. The same magnets as Example 1 were used in Example 4. In this case, the substrate 401 was not obliquely processed, i.e., it was a flat plate type substrate. Except for this, an optical isolator was manufactured by the same process as Example 1.

In the Examples, the optical elements were obliquely processed, so that the trouble of the oblique processing for a substrate can be saved, and a residual reflection in the AR coating face for air of the polarizer 405 with respect to an incident light can be eliminated to a different direction from the incident light. In this case, as a prior art shown in FIG. 5, if optical elements were cut vertically and obliquely disposed in a lateral direction on a substrate 501, the optical elements were not disposed effectively in terms of an optical transmission area, and an extra distance between magnets 510 and 511 were required, so that this aspect was not suitable for is the miniaturization of isolators. However, as shown in FIG. 4(b), since the incident side optical elements were obliquely processed, the present invention has important advantages that isolators can be miniaturized without an extra distance between magnets, and optical element materials can be used most efficiently.

The present invention is not limited to the embodiments described above. The above-described embodiments are mere examples, and those having the substantially same structure as that described in the appended claims and providing the similar functions and advantages are included in the scope of the present invention.

What is claimed is:

1. An optical isolator constituted by disposing optical elements comprising at least three polarizers and two faraday rotators with respect to a forward direction of light, wherein magnets, which are magnetized so that these magnetic poles are different from each other, are oppositely disposed by inserting the optical elements therebetween, the optical elements are constituted by disposing a first polarizer, a first faraday rotator, a second polarizer, a second faraday rotator and a third polarizer in order, the first and the third polarizers have the same transmission polarizing direction, and a faraday rotation direction of the first faraday rotator is different from that of the second faraday rotator toward a forward direction of light.

2. The optical isolator according to claim 1, wherein the optical elements are constituted by further disposing a fourth polarizer between the first faraday rotator and the second faraday rotator.

3. The optical isolator according to claim 1, wherein the first and the second faraday rotators are both latching type faraday rotators, and the magnets are omitted therefrom.

4. The optical isolator according to claim 2, wherein the first and the second faraday rotators are both latching type faraday rotators, and the magnets are omitted therefrom.

5. The optical isolator according to claim 1, wherein optical elements (polarizers and faraday rotators) and/or magnets are fixed on a flat plate type substrate, and when mounting them, a transmission polarizing direction of polarizers disposed on both ends of a forward direction of light is in parallel with a disposition plane of the substrate.

6. The optical isolator according to claim 2, wherein optical elements (polarizers and faraday rotators) and/or magnets are fixed on a flat plate type substrate, and when mounting them, a transmission polarizing direction of polarizers disposed on both ends of a forward direction of light is in parallel with a disposition plane of the substrate.

7. The optical isolator according to claim 3, wherein optical elements (polarizers and faraday rotators) and/or magnets are fixed on a flat plate type substrate, and when mounting them, a transmission polarizing direction of polarizers disposed on both ends of a forward direction of light is in parallel with a disposition plane of the substrate.

8. The optical isolator according to claim 4, wherein optical elements (polarizers and faraday rotators) and/or magnets are fixed on a flat plate type substrate, and when mounting them, a transmission polarizing direction of polarizers disposed on both ends of a forward direction of light is in parallel with a disposition plane of the substrate.

9. The optical isolator according to claim 1, wherein at least a polarizer in an incident side is obliquely disposed.

10. The optical isolator according to claim 2, wherein at least a polarizer in an incident side is obliquely disposed.

11. The optical isolator according to claim 3, wherein at least a polarizer in an incident side is obliquely disposed.

12. The optical isolator according to claim 4, wherein at least a polarizer in an incident side is obliquely disposed.

13. The optical isolator according to claim 5, wherein at least a polarizer in an incident side is obliquely disposed.

14. The optical isolator according to claim 6, wherein at least a polarizer in an incident side is obliquely disposed.

15. The optical isolator according to claim 7, wherein at least a polarizer in an incident side is obliquely disposed.

16. The optical isolator according to claim 8, wherein at least a polarizer in an incident side is obliquely disposed.

17. An optical isolator, wherein the optical element according to claim 9 is obliquely disposed by oblique-processing a cut surface of the optical element.

18. An optical isolator, wherein the optical element according to claim 10 is obliquely disposed by oblique-processing a cut surface of the optical element.

19. An optical isolator, wherein the optical element according to claim 11 is obliquely disposed by oblique-processing a cut surface of the optical element.

20. An optical isolator, wherein the optical element according to claim 12 is obliquely disposed by oblique-processing a cut surface of the optical element.

21. An optical isolator, wherein the optical element according to claim 13 is obliquely disposed by oblique-processing a cut surface of the optical element.

22. An optical isolator, wherein the optical element according to claim 14 is obliquely disposed by oblique-processing a cut surface of the optical element.

23. An optical isolator, wherein the optical element according to claim 15 is obliquely disposed by oblique-processing a cut surface of the optical element.

24. An optical isolator, wherein the optical element according to claim 16 is obliquely disposed by oblique-processing a cut surface of the optical element.

25. An optical isolator, wherein the optical element according to claim 17 is obliquely disposed from a direction perpendicular to a mating surface of the optical element and a substrate along a forward direction of light.

26. An optical isolator, wherein the optical element according to claim 18 is obliquely disposed from a direction perpendicular to a mating surface of the optical element and a substrate along a forward direction of light.

27. An optical isolator, wherein the optical element according to claim 19 is obliquely disposed from a direction perpendicular to a mating surface of the optical element and a substrate along a forward direction of light.

28. An optical isolator, wherein the optical element according to claim 20 is obliquely disposed from a direction perpendicular to a mating surface of the optical element and a substrate along a forward direction of light.

29. An optical isolator, wherein the optical element according to claim 21 is obliquely disposed from a direction perpendicular to a mating surface of the optical element and a substrate along a forward direction of light.

30. An optical isolator, wherein the optical element according to claim 22 is obliquely disposed from a direction perpendicular to a mating surface of the optical element and a substrate along a forward direction of light.

31. An optical isolator, wherein the optical element according to claim 23 is obliquely disposed from a direction perpendicular to a mating surface of the optical element and a substrate along a forward direction of light.

32. An optical isolator, wherein the optical element according to claim 24 is obliquely disposed from a direction perpendicular to a mating surface of the optical element and a substrate along a forward direction of light.
